(19) United States
(12) Patent Application Publication
(10) Pub. No.: US 2006/0093898 A1
(43) Pub. Date: May 4, 2006

(54) Lithium rechargeable battery

(76) Inventors: Yoon Tai Kwak, Youngin-si (KR); Su Jin Han, Youngin-si (KR); Eui Sun Hong, Youngin-si (KR); Jeong Man Park, Youngin-si (KR); Hee Sun Yang, Youngin-si (KR)

Correspondence Address: H.C. PARK & ASSOCIATES, PLC, 8500 LEESBURG PIKE, SUITE 7500, VIENNA, VA, 22182, US

(21) Appl. No.: 11/230,537

(22) Filed: Sep. 21, 2005

(30) Foreign Application Priority Data
Sep. 22, 2004 (KR) 10-2004-0076145

(51) Int. Cl. H01M 2/14

(52) U.S. Cl. 429/94; 429/129

(57) ABSTRACT

A lithium rechargeable battery includes an electrode assembly that has a first electrode and a second electrode that are wound together with a separator interposed between them, a can that houses the electrode assembly, and a heat-resistant member that is positioned in between the bottom of the interior of the can and the electrode assembly.

### CROSS REFERENCE TO RELATED APPLICATION

This application claims priority to and the benefit of Korean Patent Application No. 10-2004-0076145, filed on Sep. 22, 2004, which is hereby incorporated by reference for all purposes as if fully set forth herein.

### BACKGROUND OF THE INVENTION

1. Field of the Invention

The present invention relates to a lithium rechargeable battery that has an electrode assembly and a lower tape that is not damaged or torn off when welding a connection lead of a protective circuit device to the bottom surface of a can. The battery of the present invention avoids short-circuiting and improves safety in the case of physical impact such as dropping or during charging/discharging.

2. Description of the Background

In general, a rechargeable battery is a battery that can be charged and discharged, in contrast with a nonrechargeable battery. Rechargeable batteries are widely used in cutting-edge electronic devices including cellular phones, laptop computers, and camcorders. In particular, a lithium rechargeable battery has an operating voltage of at least 3.6 V, which is three times larger than that of a nickel-cadmium battery or a nickel-hydrogen battery that are frequently used as the power source of portable electronic devices. The lithium rechargeable battery also has a high energy density and thus, has rapidly prevailed in the industry.

FIG. 1 is an exploded perspective view of a conventional can-type lithium rechargeable battery and FIG. 2 is a perspective view of an electrode assembly.

Referring to FIG. 1, the lithium rechargeable battery is formed by placing an electrode assembly 12 including a first electrode 13, a second electrode 15, and a separator 14 into a can 10 together with an electrolyte and sealing the top of the can 10 with a cap assembly 70.

The cap assembly 70 includes a cap plate 71, an insulation plate 72, a terminal plate 73, and an electrode terminal 74. The cap assembly 70 is coupled with the top opening of the can 10 and seals it. An insulation case 79 is installed in the upper portion of the electrode assembly 12 to prevent the electrode assembly 12 from contacting the cap assembly 70 and the can 10.

The cap plate 71 is a metal plate with size and shape corresponding to the top opening of the can 10. The cap plate 71 has a terminal through-hole that is formed at the center thereof into which the electrode terminal 74 is inserted. When the electrode terminal 74 is inserted into the terminal through-hole, a tubular gasket 75 is coupled with the outer surface of the electrode terminal 74 for insulation between the electrode terminal 74 and the cap plate 71. The cap plate 71 has an electrolyte injection hole 76 formed on a side thereof with a predetermined size. After the cap assembly 70 is assembled on the top opening of the can 10, an electrolyte is injected through the electrolyte injection hole 76 which is then sealed by a plug 77.

The electrode terminal 74 is coupled with the second electrode tab 17 of the second electrode 15 or to the first electrode tab 16 of the first electrode 13 and acts as a second electrode terminal or a first electrode terminal, respectively. Insulation tapes 18 are wound around the portions through which the first electrode tab 16 and the second electrode tab 17 are drawn from the electrode assembly 12, respectively, to avoid a short circuit between the electrodes 13 and 15. The first electrode or second electrode may act as a positive electrode or a negative electrode.

Referring to FIG. 2, the lower portion of the electrode assembly 12 is wound by a lower tape 20 to maintain the shape of the electrode assembly, prevent the electrode assembly from being damaged when being placed into the can, and facilitate the insertion.

A secondary protective device or a protective circuit module is placed into a battery pack while being coupled with the can-type lithium rechargeable battery configured as described above along with connection leads, one of which is coupled with the bottom of the can.

When the connection lead of the protective device is coupled with the bottom of the can by ultrasonic waves or resistance welding, however, the lower tape 20 of the electrode assembly may be damaged or torn off. If the battery is subject to a physical impact (such as being dropped) when the lower tape is damaged or torn off, the battery may vibrate or may even be short-circuited during charging/discharging.

### SUMMARY OF THE INVENTION

The present invention provides a lithium rechargeable battery that comprises an electrode assembly and a lower tape that is not damaged or torn off when coupling the connection lead of the protective circuit device to the bottom surface of the can. This avoids short-circuiting of the battery and improves safety in case of physical impact or during charging/discharging.

Additional features of the invention will be set forth in the description which follows, and in part will be apparent from the description, or may be learned by practice of the invention.

The present invention discloses a lithium rechargeable battery that includes an electrode assembly that has a first electrode and a second electrode that are wound together with a separator interposed between them, a can that houses the electrode assembly, and a heat-resistant member that is positioned between the bottom of the interior of the can and the electrode assembly.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an exploded perspective view of a conventional rechargeable battery.

FIG. 2 is a perspective view of a conventional electrode assembly.

FIG. 3, FIG. 4A, and FIG. 4B are perspective views of a lithium rechargeable battery can that is equipped with a heat-resistant member according to an exemplary embodiment of the present invention.

FIG. 5 is a perspective view of an electrode assembly that is equipped with a heat-resistant member according to an exemplary embodiment of the present invention.

FIG. 6 is a sectional view of a process for coating the lower portion of a lithium rechargeable battery can with a heat-resistant paint according to an exemplary embodiment of the present invention.

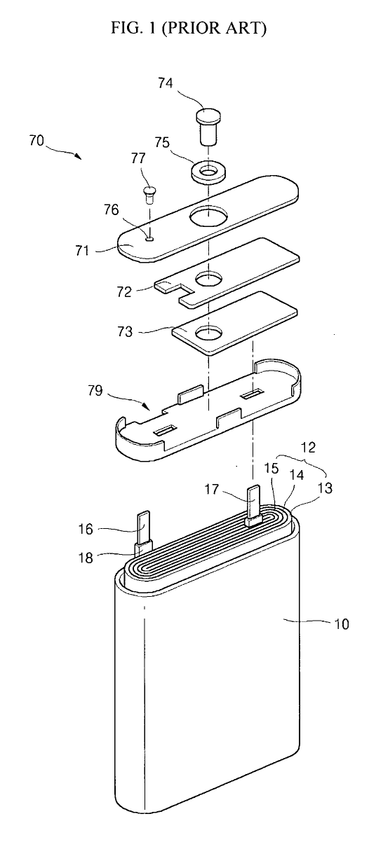

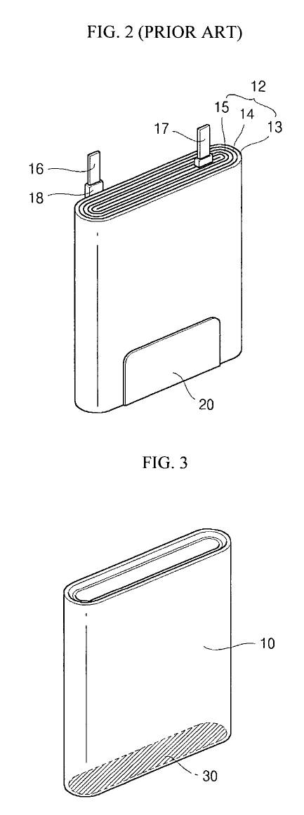

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

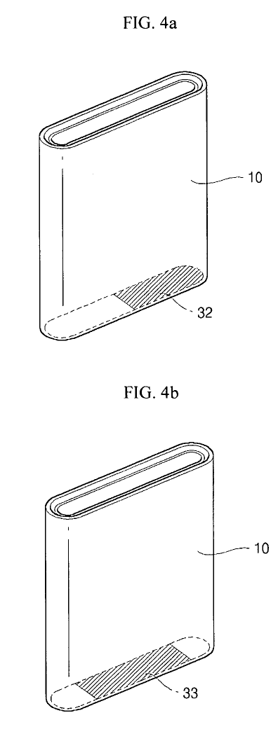

FIG. 3, FIG. 4A, and FIG. 4B are perspective views of a lithium rechargeable battery can that is equipped with a heat-resistant member according to an exemplary embodiment of the present invention.

As shown in FIG. 3, the can 10 has a heat-resistant member 30 that is positioned on the lower portion of its interior. The heat-resistant member 30 may have a size and a shape that correspond to the lower portion of the interior of the can 10.

Referring to FIG. 4A and FIG. 4B, the heat-resistant member 32 and 33 respectively, according to the present invention may be positioned only on a part of the lower portion of the interior of the can 10. For example, it may be positioned on a part of the lower portion of the interior of the can that corresponds to a part of the bottom of the can, to which the connection lead of a protective device is welded.

The heat-resistant member 30 is about 10 μm to about 100 μm thick and more preferably about 20 μm to about 50 μm thick. If the heat-resistant member is less than 10 μm thick, the heat-resistance is insufficient to prevent the lower tape of the electrode assembly from being damaged. If the heat-resistant member is more than 100 μm thick, the extra thickness of the bottom of the can may adversely affect the containing space of the electrode assembly.

The heat-resistant member 30 that is positioned on the lower portion of the interior of the can 10 prevents the lower tape of the electrode assembly from being damaged or fractured when the connection lead of a protective device is coupled with the bottom surface of the can and protects the electrode assembly when it is subject to an impact. The heat-resistant member 30 may be provided as a heat-resistant film or a heat-resistant coating, for example. Generally, the thickness of a heat-resistant coating is easier to adjust than the thickness of a film and a response to a change in the shape of the can is quicker with a coating than a film.

The heat-resistant film may comprise a material that has a continuous service temperature of about 150° C. to about 300° C. (measured by UL746B), considering heat-resistance. The heat-resistant film may include, but is not limited to polyimide (PI), polyetherimide (PEI), polyethylene terephthalate (PET), polyethylene naphthalate (PEN), polyetheretherketone (PEEK), polyphenylenesulfide (PPS), or polyethersulfone (PES).

A PI film is first subject to solution casting in polyamic acid (PAA) to heat it and volatilize the solvent. It is then heated at a high temperature (approximately 400° C.) for imidization to complete the formation of the film. The PI film has excellent resistance to heat and cold, as well as good electrical properties and is widely used in the field.

A PEI film is an amorphous thermoplastic resin that has a high glass transition temperature (T_{g}: 219° C.). It also has excellent heat-resistance, good dimensional stability, and low temperature-dependence. The PEI resin can be processed easily when melted and has characteristics similar to PI and PET/PEN resins. Therefore, it is used when a PET film cannot be used and a heat-resistance less than that offered by a PI film is required.

A PEN film has a rigid molecular chain structure, which is an important property of a polyester film. Therefore, it has a reasonable elongation ratio and a higher tensile strength, impact strength, and fracture strength and a smaller thickness than a PET film. The PEN film has a melting point of 266° C. and a glass transition temperature of 123° C., which is approximately 50° C. higher than that of the PET film. As such, it has excellent thermal dimensional stability and corresponds to the “F-class heat-resistant film” standard which is a long-term heat-aging temperature index under US UL746B Standard. It also has excellent electrical insulation properties and resistance to drug and hydrolysis.

A PEEK film has such excellent thermal stability that it can be used at up to 260° C., has good resistance to chemical agents, and has electrical properties. Particularly, it can be very efficiently used with a conventional adhesive such as an epoxy or cyanoarylate, or a lamination that has a composite structure.

A PPS film is a transparent film that has excellent heat-resistance, dimensional stability, radiation-resistance, chemical-resistance, and is non-flammable. It also has low degree of absorption and exhibits little change in electrical property as the temperature changes.

A PES film has good transparency, a high glass transition temperature (T_{g}: 223° C.), a low degree of expansion (CTE: 2.3×10⁻⁵/° C.), and excellent mechanical strength.

As described above, the PI, PEI, PEN, PEEK, PPS, and PES films that have excellent heat-resistance, electrical insulation properties, and chemical-resistance do not react with the electrolyte when used in a lithium rechargeable battery and protect the lower tape of the electrode assembly from heat and physical impact.

A comparison of basic physical properties of the PET and PI films, as well as the PEI film (SUPERIO®), is given below in Table 1.

TABLE 1

| Physical | | | SUPERIO-UT | | PET | PI | Test |
|---|---|---|---|---|---|---|---|
| properties | Item | Unit | E type | F type | film | film | Method |
| Thermal | Glass transition | ° C. | 216 | 226 | 69 | | DSC |
| properties | temperature | | | | | | |
| | Continuous service | ° C. | — | 180 | 105 | 220 | UL-746B |
| | temperature | ° C. | — | 160 | 105 | 220 | |
| | Mechanical | | | | | | |
| | Electrical | | | | | | |
| | Linear expansion | cm/cm | 4.9 × 10⁻⁵ | 5.2 × 10⁻⁵ | 2.0 × 10⁻⁵ | 2.0 × 10⁻⁵ | ASTM D-696 |
| | coefficient | ° C. | | | | | |
| | Thermal | % | 0.2 | 0.2 | | | 200° C. × 30 min |
| | contraction ratio | | | | | | |
| Mechanical | Tensile strength | kg_{f}/mm² | 12 | 12.5 | 22 | 24 | JIS C-2318 |
| properties | Fracture | % | 120 | 100 | 120 | 70 | JIS C-2318 |
| | elongation ratio | | | | | | |
| | Tensile elasticity | kg_{f}/mm² | 320 | 290 | 500 | 400 | ASTM D-638 |
| Electrical | Insulation | KV | 10.0 | 10.5 | 9.0 | 10.8 | JIS C-2318 |
| properties | failure voltage | | | | | | |
| | Volumetric | Ω-cm | 10¹⁷ | 10¹⁷ | 10¹⁷ | 10¹⁸ | JIS C-2318 |
| | resistance ratio | | | | | | |
| | Dielectric | | 3.5 | 3.0 | 3.4 | 3.5 | JIS C-2318 |
| | constant (1 KHz) | | | | | | |
| Other | Density | g/m³ | 1.27 | 1.27 | 1.40 | 1.42 | ASTM D-1505 |
| properties | Absorption ratio | % | 0.4 | 0.6 | 0.3 | 2.9 | ASTM D-570 |
| | Flammability | | VTM-0 | VTM-0 | — | V-0 | UL-94 |
| | (25μ) | | | | | | |
| | Alkali | | Δ | Δ | Δ | ◯ | |

The heat-resistant film may be used without any adhesive or it may include an adhesive layer. The adhesive layer may include a heat-resistant adhesive that can endure heat that is generated when the connection lead of the protective device is welded to the bottom of the can, but is not limited thereto. For example, the heat-resistant adhesive may include a polyimide-based adhesive, a silicon-based adhesive, a silicon/imide-based adhesive, and an epoxy-based adhesive.

A polyimide-based adhesive has excellent characteristics including heat-resistance, mechanical properties, and electrical properties.

A silicon-based adhesive may have polydimethylsiloxane rubber as its main component and a low molecular weight silicon resin including dimethylsiloxane added thereto. It can be used in a wide temperature range and has excellent heat-resistance and durability.

A silicon/imide-based adhesive is a thermoplastic elastomer (developed by General Electric) that has excellent mechanical strength, elasticity, adhesive properties with various metals, and a wide-range of thermal stability.

An epoxy-based adhesive has improved heat-resistance by hardening a multifunctional epoxy resin with an aromatic amine or an aromatic acid anhydride. It includes a component that has excellent heat-resistance such as an aromatic ring or an imide ring that is introduced into molecules for higher cross-linking density and improved heat-resistance. Thus, it can be used for a long period of time even at 200° C.

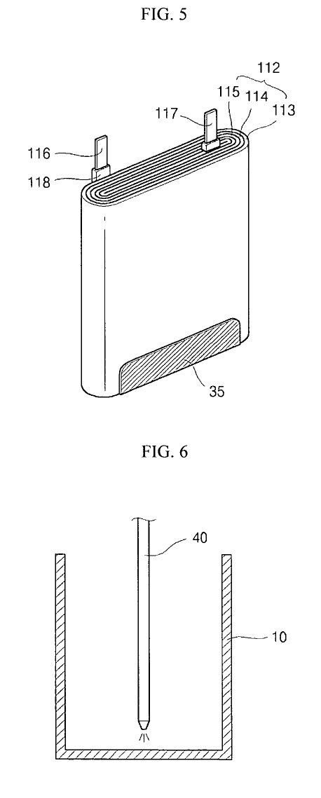

FIG. 5 is a perspective view of an electrode assembly that is equipped with a heat-resistant member according to an exemplary embodiment of the present invention. Referring to FIG. 5, the electrode assembly 12 has a heat-resistant member 35 that is coupled with the lower portion thereof. Although it is not shown in the drawing, the heat-resistant member 35 may be positioned on the lower portion of the electrode assembly 12 with a lower tape.

The heat-resistant member 35 that is coupled with the lower portion of the electrode assembly 12 is not easily damaged when the connection lead of a protective device is coupled with the bottom surface of the can and protects the electrode assembly in a safer manner. The electrode assembly 112 includes a first electrode 113, a second electrode 115, and a separator 114. The first electrode 113 and the second electrode 115 are laminated with the separator 114 interposed between them and are wound into a jelly roll.

The first electrode 113 and the second electrode 115 have a first electrode tab 116 and a second electrode tab 117 that are coupled thereto, respectively. The electrode tabs may be coupled with the electrodes by welding including laser welding, ultrasonic welding, and resistance welding or with a conductive adhesive for electrical conductance, while being drawn out in the upward direction. Insulation tapes 118 are wound around the portions through which the first electrode tab 116 and the second electrode tab 117 are drawn from the electrode assembly 112, respectively, to avoid a short-circuit between the first electrode 113 and the second electrode 115.

The first electrode 113 and the second electrode 115 have opposite polarities and may act as a positive electrode or a negative electrode, respectively. The first electrode 113 and the second electrode 115 may include an electrode current collector and an electrode active material (i.e., a positive electrode active material or a negative electrode active material) that is applied to at least one surface of the current collector.

When the first electrode 113 or the second electrode 115 is used as a positive electrode, the electrode current collector may include stainless steel, nickel, aluminum, titanium, or an equivalent thereof, or it may include aluminum or stainless steel that has been surface-treated with carbon, nickel, titanium, or silver. Among them, aluminum or an aluminum alloy is preferred. When the first electrode 113 or the second electrode 115 is used as a negative electrode, the electrode current collector may include stainless steel, nickel, copper, titanium, or an equivalent thereof, or it may include copper or stainless steel that has been surface-treated with carbon, nickel, titanium, or silver. Among them, copper or a copper alloy is preferred.

The positive electrode active material may include a lithium-containing transition metal oxide or a lithium-chalcogenide compound. For example, metal oxides such as LiCoO₂, LiNiO₂, LiMnO₂, LiMn₂O₄, or LiNi_{1-x-y}CoₓM_{y}O₂ (0≦x≦1, 0≦y≦1, 0≦x+y≦1, M is metal such as Al, Sr, Mg, La or the like) may be used. The negative electrode active material may include a carbon material such as crystalline carbon, amorphous carbon, carbon composite, and carbon fiber, lithium metal, or a lithium alloy.

The separator 114 prevents short-circuiting between the first electrode 113 and the second electrode 115 and provides a passage for the flow of lithium ions. The separator 114 may comprise a polyolefin-based polymer film such as polypropylene or polyethylene, a multiple film thereof, a micro-porous film, a woven fabric, or a non-woven fabric as widely known in the art.

The heat-resistant member of the present invention may also be coated. FIG. 6 is a sectional view of a process for coating the lower portion of a lithium rechargeable battery can with a heat-resistant paint according to an exemplary embodiment of the present invention.

As shown in FIG. 6, a heat-resistant paint may be coated on the lower portion of the interior of the can 10 through a nozzle 40 to form a heat-resistant coating with a predetermined thickness.

Coating methods may include, but are not limited to air spray painting, airless painting, and electrostatic spray painting.

The air spray painting method uses compressed air and can achieve a very fine degree of atomization during a finishing process of surface painting. It can use various spray patterns and adjust the viscosity of the paint in a wide range. The aesthetic quality of the painted layer depends on the amount of paint, the pressure of the air, and the adjustment of flow rate. The air spray can be applied to almost every surface regardless of paint and painted matter, and only an air compressor, a paint supply apparatus, a spray gun, and a painting room are required. Such a simple process decreases the cost and increases the painting speed. However, the air spray painting may entail a large loss of paint because when the paint is atomized and the compressed air rebounds from the painted matter, a considerable amount of paint particles are lost.

The airless spray painting method does not use compressed air. Instead, paint is pumped at increased fluid pressures through a small opening at the tip of the spray gun to achieve atomization. Pressure is generally supplied to the gun by an air-driven reciprocating fluid pump. When the pressurized paint enters the low pressure region in front of the gun, the sudden drop in pressure causes the paint to be atomized.

The electrostatic spray painting method applies strong static electricity to a painting surface material so that paint particles are attached thereto by electrostatic force. This method can reduce paint loss.

The heat-resistant paint may include a silicon resin, a silicon alkyd resin, a urethane resin, or a silicon acryl resin.

Alternately, the heat-resistant coating may be formed by a fluorocarbon resin coating. The fluorocarbon resin coating has excellent heat-resistance, chemical-resistance, non-stick properties, and low temperature stability. The fluorocarbon resin may include, but is not limited to polytetrafluroethylene (PTFE), ethylene/tetrafluroethylene (ETFE), perfluoroalkoxy (PFA), and fluorinated ethylene propylene copolymer (FEP). The fluorocarbon resin may be continuously used at up to 290° C. The continuous service temperatures of PTFE and PFA are 260° C., and those of FEP and ETFE are 200° C. and 160° C. respectively. A deactivated hard coating layer may be formed by applying the fluorocarbon resin in the form of liquid or powder to the surface of any kind of metal and then heat-plasticizing at the predetermined temperature.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A rechargeable battery, comprising:
an electrode assembly that has a first electrode and a second electrode that are wound together with a separator interposed between them;
a can for containing the electrode assembly; and
a heat-resistant member that is positioned in between the bottom of the interior of the can and the electrode assembly.

2. The rechargeable battery of claim 1,
wherein the heat-resistant member is about 10 μm to about 100 μm thick.

3. The rechargeable battery of claim 2,
wherein the heat-resistant member is about 20 μm to about 50 μm thick.

4. The rechargeable battery of claim 1,
wherein the heat-resistant member is positioned on the bottom of the interior of the can.

5. The rechargeable battery of claim 4,
wherein the heat-resistant member is positioned on a part of the bottom of the interior of the can.

6. The rechargeable battery of claim 1,
wherein the heat-resistant member is positioned on the lower portion of the electrode assembly.

7. The rechargeable battery of claim 1,
wherein the heat-resistant member is positioned both on the bottom of the interior of the can and on the electrode assembly.

8. The rechargeable battery of claim 1,
wherein the heat-resistant member is a heat-resistant film.

9. The rechargeable battery of claim 8,
wherein the heat-resistant film has a continuous service temperature of about 150° C. to about 300° C.

10. The rechargeable battery of claim 8,
wherein the heat resistant film comprises at least one selected from the group consisting of polyimide, polyetherimide, polyethylene terephthalate, polyethylene naphthalate, polyetheretherketone, polyphenylenesulfide, and polyethersulfone.

11. The rechargeable battery of claim 8,
wherein the heat-resistant film further comprises a layer of an adhesive.

12. The rechargeable battery of claim 11,
wherein the adhesive is a heat-resistant adhesive.

13. The rechargeable battery of claim 12,
wherein the adhesive is at least one selected from the group consisting of a polyimide-based adhesive, a silicon-based adhesive, a silicon/polyimide-based adhesive, and an epoxy-based adhesive.

14. The rechargeable battery of claim 1,
wherein the heat-resistant member comprises a heat-resistant coating.

15. The rechargeable battery of claim 14,
wherein the heat-resistant coating is formed by spraying heat-resistant paint.

16. The rechargeable battery of claim 15,
wherein the heat-resistant paint is at least one selected from the group consisting of silicon resin, modified silicon resin, urethane resin, silicon alkyd resin, and silicon acryl resin.

17. The rechargeable battery of claim 14,
wherein the heat-resistant coating comprises a fluorocarbon resin.

18. The rechargeable battery of claim 17,
wherein the fluorocarbon resin is at least one selected from the group consisting of polytetrafluoroethylene, ethylene/tetrafluoroethylene, perfluoroalkoxy, and fluorinated ethylene propylene copolymer.
